(19) United States
(12) Patent Application Publication
(10) Pub. No.: US 2020/0175647 A1
(43) Pub. Date: Jun. 4, 2020

(54) METHODS AND APPARATUS FOR ENHANCED DOWNSCALING

(71) Applicant: QUALCOMM Incorporated, San Diego, CA (US)

(72) Inventors: Hyung Cook KIM, San Diego, CA (US); Xiaoyun JIANG, San Diego, CA (US); Shang-Chih CHUANG, San Diego, CA (US)

(21) Appl. No.: 16/206,557

(22) Filed: Nov. 30, 2018

(51) Int. Cl. G06T 3/40; G06T 7/00; G06T 5/50

(52) U.S. Cl. CPC G06T 3/40; G06T 2207/20016; G06T 5/50; G06T 7/0002

(57) ABSTRACT

The present disclosure relates to methods and devices for image processing. In one aspect, the device may obtain a first image including a set of multiple first pixels. The device can also determine a scale factor for scaling the first image from the first pixels to a set of multiple second pixels. Also, a number of the second pixels can be less than a number of the first pixels, where each second pixel has a second pixel width. Additionally, the device can determine a value for each second pixel based on a weighted average, where each component of the weighted average can be a function of an overlapping area associated with each second pixel and values of corresponding first pixels of the multiple first pixels. The device can also generate a second image based on the determined values for each second pixel.

### TECHNICAL FIELD

The present disclosure relates generally to processing systems and, more particularly, to one or more techniques for image processing in processing systems.

### INTRODUCTION

Computing devices often utilize an image signal processor (ISP), a central processing unit (CPU), a graphics processing unit (GPU), an image processor, or a video processor to accelerate the generation of image, video, or graphical data. Such computing devices may include, for example, computer workstations, mobile phones such as so-called smartphones, embedded systems, personal computers, tablet computers, and video game consoles. ISPs or CPUs can execute image, video, or graphics processing systems that includes multiple processing stages that operate together to execute image, video, or graphics processing commands and output one or more frames. In some aspects, a CPU may control the operation of one or more additional processors by issuing one or more image, video, or graphics processing commands. Modern day CPUs are typically capable of concurrently executing multiple applications, each of which may need to utilize another processor during execution. A device that provides content for visual presentation on a display may include an ISP, a GPU, or a CPU.

ISPs, GPUs, or CPUs can be configured to perform multiple processes in an image, video, or graphics processing system. With the advent of faster communication and an increase in the quality of content, e.g., any content that is generated using an ISP, GPU, or CPU, there has developed a need for improved image, video, or graphics processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a first apparatus are provided. The apparatus may be an image processor. In one aspect, the apparatus may obtain a first image including multiple first pixels, where each first pixel has a first pixel width. The apparatus can also determine a scale factor for scaling the first image from the multiple first pixels to multiple second pixels. In some aspects, a number of the multiple second pixels can be less than a number of the multiple first pixels, where each second pixel has a second pixel width. Additionally, the apparatus can determine a value for each second pixel based on a weighted average, where each component of the weighted average can be a function of an overlapping area associated with each second pixel and values of corresponding first pixels of the multiple first pixels. In some aspects, the overlapping area can be centered on each second pixel and have a width greater than the second pixel width. Moreover, the apparatus can generate a second image based on the determined values for each second pixel, where the second image can be a downscaled image from the first image. In some aspects, the apparatus can be a wireless communication device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example system in accordance with the techniques of this disclosure.

FIGS. 2A-2C illustrate examples of downscaling an image according to the present disclosure.

FIGS. 3A and 3B illustrate examples of noise associated with an image and a downscaled image according to the present disclosure.

FIG. 4 illustrates an example of downscaling an image according to the present disclosure.

FIGS. 5A and 5B illustrate examples of noise associated with a downscaled image according to the present disclosure.

FIGS. 6A-6C illustrate examples of downscaling an image according to the present disclosure.

FIGS. 7A and 7B illustrate examples of downscaling an image according to the present disclosure.

FIGS. 8A-8D illustrate examples of noise associated with a downscaled image according to the present disclosure.

FIG. 9 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include image signal processors (ISPs), central processing units (CPUs), graphics processing units (GPUs), image processors, video processors, microprocessors, microcontrollers, application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and executed the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can be a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to image content, high dynamic range (HDR) content, video content, graphical content, or display content. In some examples, as used herein, the phrases “image content” or “video content” may refer to a content generated by a processing unit configured to perform image or video processing. For example, the phrases “image content” or “video content” may refer to content generated by one or more processes of an image or video processing system. In some examples, as used herein, the phrases “image content” or “video content” may refer to content generated by an ISP or a CPU. In some examples, as used herein, the term “display content” may refer to content generated by a processing unit configured to perform display processing. In some examples, as used herein, the term “display content” may refer to content generated by a display processing unit. Image or video content may be processed to become display content. For example, an ISP or CPU may output image or video content, such as a frame, to a buffer, e.g., which may be referred to as a frame buffer. A display processing unit may read the image or video content, such as one or more frames from the buffer, and perform one or more display processing techniques thereon to generate display content. For example, a display processing unit may be configured to perform composition on one or more generated layers to generate a frame. As another example, a display processing unit may be configured to compose, blend, or otherwise combine two or more layers together into a single frame. A display processing unit may be configured to perform scaling, e.g., upscaling or downscaling on a frame. In some examples, a frame may refer to a layer. In other examples, a frame may refer to two or more layers that have already been blended together to form the frame, i.e., the frame includes two or more layers, and the frame that includes two or more layers may subsequently be blended.

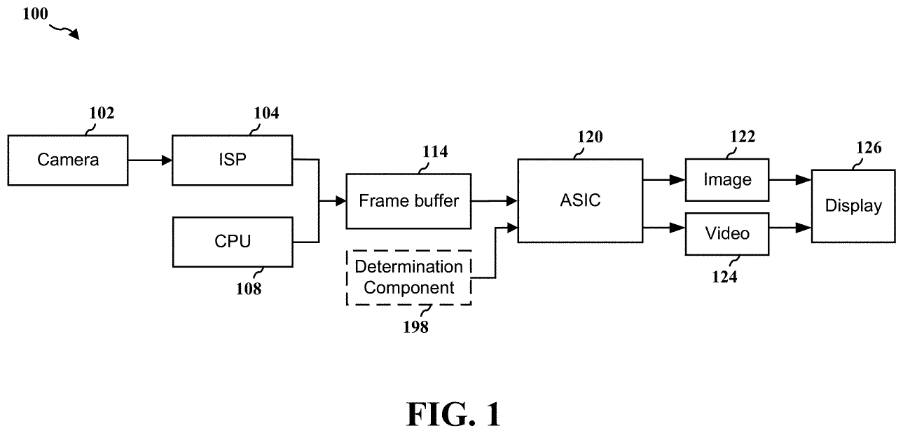

FIG. 1 is a block diagram illustrating system 100 configured to implement one or more techniques of this disclosure. The system 100 can include camera 102, ISP 104, CPU 108, frame buffer 114, ASIC 120, image processing unit 122, video processing unit 124, display 126, and determination component 198. Camera 102 can generate one or more frames via a variety of processing types. For instance, camera 102 can utilize any type of image or HDR processing, including snapshot or traditional processing, zig zag processing, spatial processing, and/or staggered processing. Additionally, ISP 104 can process the frames from camera 102. In some aspects, once the ISP 104 processes the frames, it can produce a frame buffer 114 for each frame. In some aspects, the frame buffer 114 can be stored or saved in a system memory or internal memory, e.g., a dynamic RAM (DRAM). In some aspects, system 100 may not include one or more of the components mentioned above that can receive frames or images, e.g., the camera 102 or the ISP 104. In these aspects, a frame or image can be received by the system or device in some other manner, e.g., via a network connection.

In some aspects, CPU 108 can run or perform a variety of algorithms for system 100. CPU 108 may also include one or more components or circuits for performing various functions described herein. For instance, the CPU 108 may include a processing unit, a content encoder, a system memory, and/or a communication interface. The processing unit, a content encoder, or system memory may each include an internal memory. In some aspects, the processing unit or content encoder may be configured to receive a value for each component, e.g., each color component of one or more pixels of image or video content. As an example, a pixel in the red (R), green (G), blue (B) (RGB) color space may include a first value for the red component, a second value for the green component, and a third value for the blue component. The system memory or internal memory may include one or more volatile or non-volatile memories or storage devices. In some examples, the system memory or the internal memory may include RAM, static RAM (SRAM), DRAM, erasable programmable ROM (EPROM), electrically erasable programmable ROM (EEPROM), flash memory, a magnetic data media, an optical storage media, or any other type of memory.

The system memory or internal memory may also be a non-transitory storage medium according to some examples. The term “non-transitory” may indicate that the storage medium is not embodied in a carrier wave or a propagated signal. However, the term “non-transitory” should not be interpreted to mean that the system memory or internal memory are non-movable or that its contents are static. As one example, the system memory or internal memory may be removed from the CPU 108 and moved to another component. As another example, the system memory or internal memory may not be removable from the CPU 108.

CPU 108 may also include a processing unit, which may be an ISP, a GPU, an image processor, a video processor, or any other processing unit that may be configured to perform image or video processing. In some examples, the processing unit may be integrated into a component of the CPU 108, e.g., a motherboard, or may be otherwise incorporated within a peripheral device configured to interoperate with the CPU 108. The processing unit of CPU 108 may also include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit may store instructions for the software in a suitable, non-transitory computer-readable storage medium, e.g., system memory or internal memory, and may execute the instructions in hardware using one or more processors to perform the techniques of this disclosure. Any of the foregoing, including hardware, software, a combination of hardware and software, etc., may be considered to be one or more processors.

In some aspects of system 100, once ISP 104 processes the multiple frames, ISP 104 can produce a frame buffer 114 for each frame. In some instances, the frame buffer 114 can be stored or saved in a memory, e.g., the system memory or internal memory. In other instances, the frame buffer can be stored, saved, or processed in the ASIC 120. ASIC 120 can process the images or frames after the ISP 104. Additionally, ASIC 120 can process data stored in the frame buffer 414. In other aspects, the ASIC 120 can be a programmable engine, e.g., a processing unit or GPU.

In another aspect of system 100, image processing unit 122 or video processing unit 124 can receive the images or frames from ASIC 120. For instance, in some aspects, image processing unit 122 or video processing unit 124 can process or combine the multiple frames from ASIC 120. Image processing unit 122 or video processing unit 124 can then send the frames to display 126. In some aspects, the display 126 may include a display processor to perform display processing on the multiple frames. More specifically, the display processor may be configured to perform one or more display processing techniques on the one or more frames generated by the camera 102, e.g., via image processing unit 122 or video processing unit 124.

In some aspects, the display 126 may be configured to display content that was previously generated. For instance, the display 126 may be configured to display or otherwise present frames that were previously processed. In some aspects, the display 126 may include a variety of display devices, such as a liquid crystal display (LCD), a plasma display, an organic light emitting diode (OLED) display, a projection display device, an augmented reality display device, a virtual reality display device, a head-mounted display, and/or any other type of display device. Display 126 may also include a single display or multiple displays, such that any reference to display 126 may refer to one or more displays 126. For example, the display 126 may include a first display and a second display. In some instances, the first display may be a left-eye display and the second display may be a right-eye display. In these instances, the first and second display may receive different frames for presentment thereon. In other examples, the first and second display may receive the same frames for presentment thereon.

Referring again to FIG. 1, in certain aspects, the system 100 may include a determination component 198 configured to obtain a first image including multiple first pixels, where each first pixel has a first pixel width. Additionally, the determination component 198 can also determine a scale factor for scaling the first image from the multiple first pixels to multiple second pixels. In some aspects, a number of the multiple second pixels can be less than a number of the multiple first pixels, where each second pixel has a second pixel width. Additionally, the determination component 198 can determine a value for each second pixel based on a weighted average, where each component of the weighted average can be a function of an overlapping area associated with each second pixel and values of corresponding first pixels of the multiple first pixels. In some aspects, the overlapping area can be centered on each second pixel and have a width greater than the second pixel width. Moreover, the determination component 198 can generate a second image based on the determined values for each second pixel, where the second image can be a downscaled image from the first image. Other example benefits are described throughout this disclosure.

Some aspects of the present disclosure can convert or adjust the size of an image, such as by increasing, i.e., upscaling, or decreasing, i.e., downscaling, the size of the original image. In order to downscale or decrease the size of an image, some aspects of the present disclosure can utilize a downscaler. In some aspects, a downscaler can be used for a number of different purposes by an image signal processor (ISP). For example, the downscaler can be an algorithm used to downscale images. Further, downscalers herein can be part of a camera processing pipeline, where the algorithm can be used to downscale images from a camera in a processing pipeline. In further aspects, downscalers can be part of the ISP within the hardware, e.g., a chip or a part thereof in a camera pipeline. In some aspects, a downscaler can be an algorithm used to downscale a stored image (e.g., post-ISP processing and/or not part of the camera processing pipeline).

Downscaling can be used for a variety of reasons. For instance, an image may need to be resized, e.g., to fit another display format or to alter the viewing magnification. In these instances, downscalers can be used to reduce the size of an image while maintaining the image quality. Some examples of applications that utilize downscaling are web browsers, image magnifiers and other zooming applications, and/or image editors.

Downscalers can have a number of different benefits when converting or downscaling images, such as having low implementation costs compared to other image conversion methods. Further, downscalers can be relatively simple to implement compared to other image conversion methods, e.g., only one line buffer may be needed to calculate a downscaled image. Downscalers herein can also have a flexible scale factor, i.e., the amount that each image is downscaled or upscaled, such that images can be reduced or increased in size by any desired amount. In some aspects, downscalers can convert or decrease the size of an image by a scale factor greater than 1. The scale factor can be any number, such that images can be decreased in size by any amount. Moreover, a large downscaling ratio may not affect other aspects of the downscaling operation, e.g., the amount the of line buffers needed to calculate a downscaled image may not increase based on a large downscaling ratio. However, in some aspects, downscalers can have issues, as discussed in detail below, when the downscaling ratio is within a certain range, e.g., from 1 to 1.3. Additionally, downscalers according to the present disclosure can have a high downscaling quality, such that the downscaling can be equivalent to a high quality of downscaling, e.g., bilinear downscaling. Further, downscalers according to the present disclosure may be able to support any type of downscaling ratios with a simple calculation.

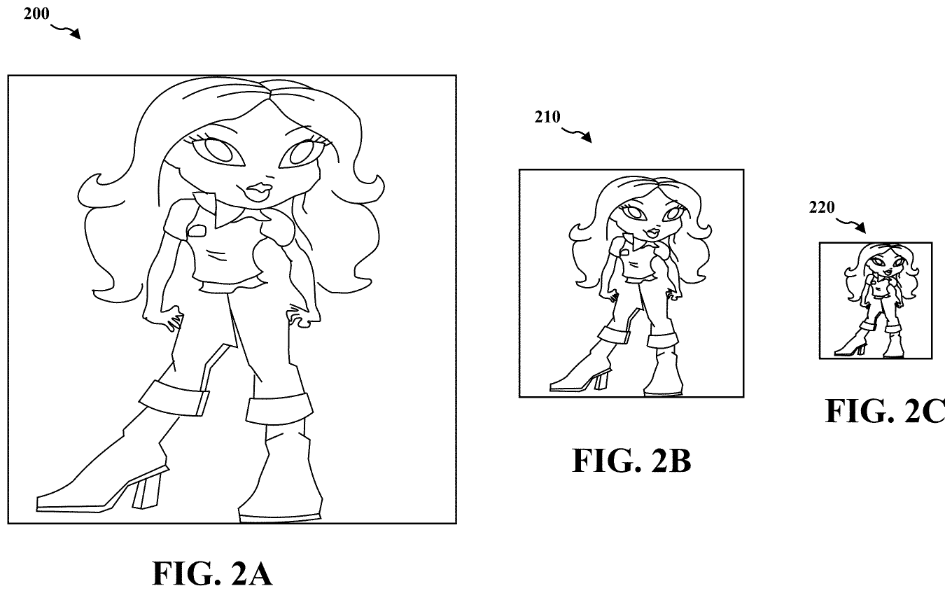

FIGS. 2A-2C illustrate examples of downscaling an image 200 according to the present disclosure. FIG. 2A shows an image 200 that can be downscaled according to a number of scale factors. For example, FIG. 2B shows an image 210 that is the result of image 200 being downscaled by a scale factor of 2. Accordingly, the dimensions in image 210 are half the size of the dimensions in image 200. Further, FIG. 2C shows an image 220 that is the result of image 200 being downscaled by a scale factor of 4. Accordingly, the dimensions in image 220 are one quarter the size of the dimensions in image 200. FIGS. 2A-2C show that the same images can be downscaled based on any scale factor and still uphold the same quality of the original image.

Some aspects of downscaling can produce unwanted side effects. For instance, when an image is downscaled, a number of noise artifacts can be produced. In some instances, these noise artifacts can disrupt the uniformity of the downscaled image. For example, the noise artifacts produced may be in the form of a grid that matches the grid used to produce the downscaled image from the originally sized image. These grid pattern artifacts may be the result of random noise in the image. For example, when there is no noise in the image, then the grid patterns may not be present. In some aspects, the aforementioned noise can be the result of neighboring pixel values being independent of one another (i.e., different color values).

In other aspects, these unwanted noise artifacts may be produced when downscaling with a certain range of scale factors. As such, in some aspects, when the downscaling ratio is closer to 1, noticeable grid patterns may be produced. For example, in some aspects, downscaling when using a scale factor of 1 to 1.3 may produce more noise artifacts than when using a different scale factor. Accordingly, some downscalers may not be able to support a small downscaling ratio. However, when downscaling with a higher scale factor, these grid pattern artifacts may not be present. For example, a scale factor or downscale ratio of 1.5 or above may not produce the aforementioned grid pattern artifacts. Moreover, these noise artifacts may be produced when using any number of downscaling methods, e.g., bilinear, bicubic, etc. In some instances, downscalers may merely crop an image in order to reduce its size. However, merely cropping the image can have a number of unwanted side effects, such as negatively influencing the image or decreasing the field of view (FOV). In contrast, downscaling an image can avoid many of these negative side effects.

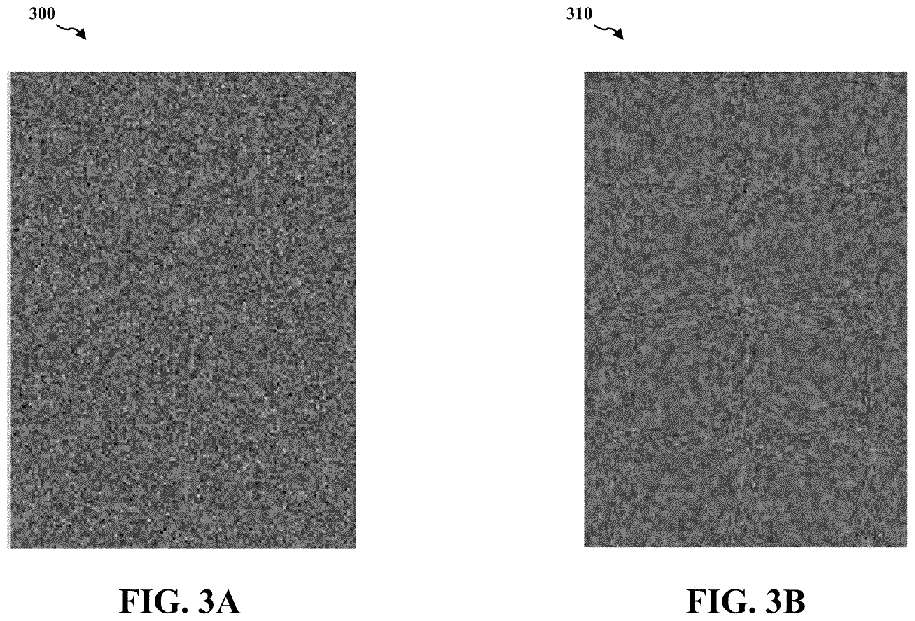

FIGS. 3A and 3B illustrate examples of noise associated with an image 300 and a downscaled image 310. More specifically, FIGS. 3A shows an image 300 before downscaling with a relatively uniform amount of noise. FIGS. 3B displays an image 310 after downscaling the image 300. Image 310 displays a number of noise artifacts that are in a grid pattern. As indicated above, the grid pattern artifacts in the image 310 can be in the form of the grid used to downscale from the original image 300. As mentioned above, the grid pattern artifacts present in image 310 may be the result of downsizing image 300 with a small scale factor.

As discussed above, cropping has unwanted side effects, such as negatively influencing the image or decreasing the FOV. Thus, reducing the size of an image without downscaling, e.g. cropping an image, may not be appropriate in many circumstances, e.g., when the full FOV is desired in the adjusted image.

Furthermore, there is a growing use of high quality images and a corresponding need to downscale at a high quality and with a small scale factor. In some instances, a downscaled image, even by a small scale factor, can save bandwidth and power to transmit and memory to store, particularly for high quality images. For example, the savings on both bandwidth and power when transmitting a downscaled image can be as much as 40%.

Downscaled pixel values according to the present disclosure can be calculated in a number of different ways. In some aspects, a downscaled pixel value can be calculated based on the average, sum, or combination of overlapping or covered pixel values from the original image. For instance, a downscaled pixel value may be the average of the original pixel values that overlap the downscaled pixel based on its phase, i.e., sampling point. In some aspects, the phase or sampling point can be the location of the center of the downscaled pixel based on the original image. For example, the phase or sampling point can be the location of the center of the downscaled pixel. Based on the location of each downscaled pixel, the phase values compared to the original image pixels may change on a pixel-by-pixel basis, e.g., as the location of each different downscaled pixel will change.

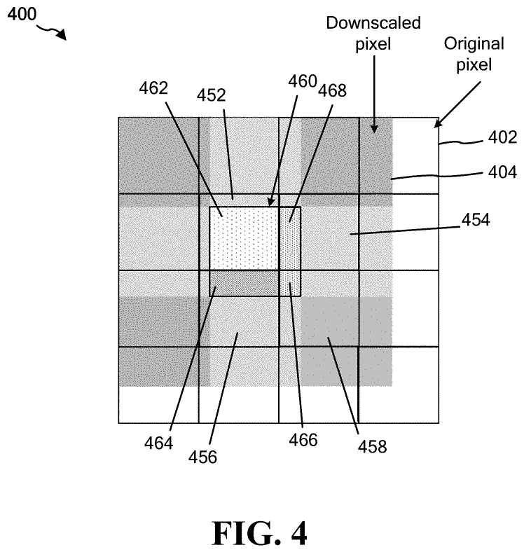

FIG. 4 illustrates an example of downscaling an image 400 according to the present disclosure. As shown in FIG. 4, the original image pixel grid 402 is the larger grid with the squares with the black grid lines. The downscaled pixel grid 404 is the smaller grid with the light gray and dark gray squares. FIG. 4 shows that some original pixels, e.g., pixel 452, pixel 454, pixel 456, and pixel 458, are being sampled to calculate the value for a downscaled pixel, e.g., pixel 460. these pixels can have any number of different pixel values, e.g., pixel values from 0 to 255 for an 8-bit pixel value. The value of the downscaled pixel 460 may be determined based on a weighted average that is a function of the area 462 multiplied by the value of the pixel 452, the area 464 multiplied by the value of the pixel 456, the area 466 multiplied by the value of the pixel 458, and the area 468 multiplied by the value of the pixel 454. As shown in FIG. 4, each original pixel does not overlap with any other original pixel. This is because each of the pixels in the original image are immediately adjacent the other pixels, but not overlapping, so the image appears as a single, clear picture. Likewise, each downscaled pixel does not overlap with any other downscaled pixel.

Each downscaled pixel in FIG. 4 is based on a number of different calculations. For instance, the size of each side of a downscaled pixel can be equal to the scale factor or downscaling ratio. For example, if the scale factor or downscaling ratio is 1.1, then the side of the each dark gray and light gray square is 1.1 pixels. If the scale factor or downscaling ratio is 1.3, then the side of the each dark gray and light gray square is also 1.3 pixels. Additionally, as indicated previously, each downscaled pixel value may be equal to the average of the original pixel values that overlap the downscaled pixel based on its phase or sampling point. For example, the value of downscaled pixel 460, e.g. P460, may be calculated based on the following equation: P460=[A462*P452+A468*P454+A464*P456+A466*P458]/A460, where P452, P454, P456, and P458 are the color values of the original pixels 452, 454, 456, and 458, respectively, A462, A468, A464, and A466 are the overlapping areas that overlap with the original pixels 452, 454, 456, and 458, respectively, and A460 is the area of downscaled pixel 460. As noted in FIG. 4, the overlapping areas A462-A468 that are used in the calculation are indicated by a different pattern in order to emphasize the different overlapping areas that contribute to the calculation of the downscale pixel 460. Accordingly, A462 will most heavily influence the value of P460, while A466 will have the least influence on P460. As mentioned above, the percentage of influence that each original pixel has on a downscaled pixel's value will change for each different downscaled pixel.

As mentioned above, downscaling can produce unwanted artifacts in the downscaled image. The reason for these artifacts is that different downscaled pixels sample a different percentage of the original image pixels. For instance, in a particularly noisy image, the percentages sampled from each original pixel to determine a downscaled pixel may change with each different downscale pixel. Accordingly, the noise level of each downscaled pixel may keep changing. For example, if one downscaled pixel value is calculated based on a sampling percentage of four original image pixels, another downscaled pixel value may use a different sampling percentage of four different original image pixels. In some aspects, the amount of noise in each downscaled image pixel may change based on the percentages taken from each of the original pixel images, which may generate a pattern of artifacts in the final downscale image. For example, if a downscaled pixel value is determined based on four equally weighted original pixels values, the downscaled pixel value will appear to have less noise than if a downscaled pixel value is determined based on four original pixel values where one or two original pixel values are weighted higher than the remaining pixels.

One of the causes of the unwanted grid pattern of artifacts may be the difference in noise between the original image pixels. In some aspects, the grid pattern of noise artifacts may be more pronounced based on the scaling factor or downscaling ratio. For instance, the grid pattern of noise artifacts may increase when using a smaller scaling factor or downscaling ratio, e.g., a scaling factor of 1.00001 to 1.3. Likewise, the grid pattern of noise artifacts may decrease, may not be visible, or may not be present when using a larger scaling factor or downscaling ratio, e.g., a scaling factor greater than 1.5.

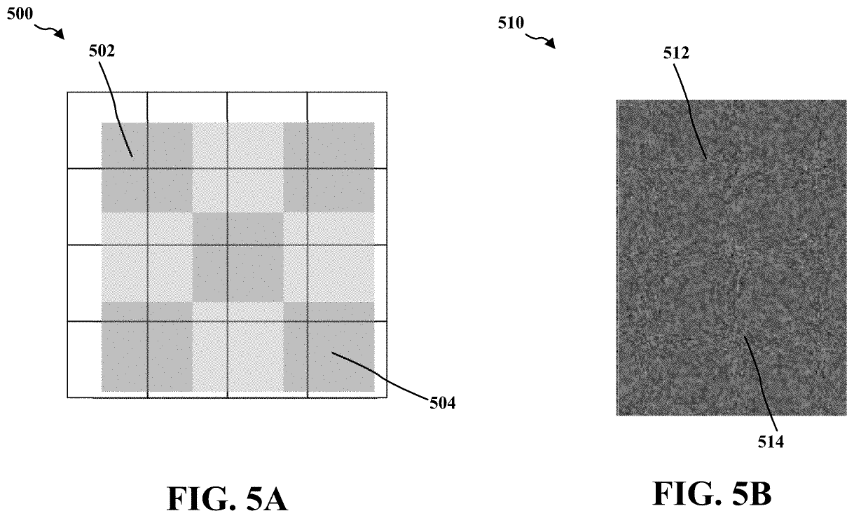

FIGS. 5A and 5B illustrate examples of noise associated with a downscaled image, according to the present disclosure. As shown in FIG. 5A, when calculating the value of the upper left dark gray pixel 502 in downscaled image 500, the weight or percentage used in the calculation is similar for each of the surrounding four original pixel squares. For instance, the areas of each original pixel used in the pixel value calculation mentioned above may be roughly equal. As each of these original pixels are roughly given the same weight, the amount of noise at pixel location 512 may be small. Accordingly, when calculating a downscaled pixel value, if the weight given to each original pixel used in the calculation is roughly the same, then it can result in a small amount of noise at this downscaled pixel location. As further shown in FIG. 5A, when calculating the value of the lower right dark gray pixel 504, the weight or percentage used in the calculation for each of the surrounding four original pixel squares is unequal. Indeed, the weight used from the bottom right original pixel is the highest, while the original pixel that contributes to the upper left portion of the downscaled pixel adds relatively little weight. This may result in the amount of noise at pixel location 514 being relatively high. As such, when the contributed weights of the original pixel squares are relatively unequal, this may result in a large amount of noise at this downscaled pixel location.

FIG. 5B illustrates the amount of noise in a downscaled image 510. As shown in FIG. 5B, downscaled image 510 includes locations with relatively low noise, e.g., pixel location 512, and locations with relatively high noise, e.g., pixel location 514. As mentioned above, the noise patterns in downscaled images may be based on a grid, e.g., the grid used to downscale from the original image. FIG. 5B shows that downscaled image 510 has noise patterns based on a grid. In downscaled images, the areas with differing amounts of noise may appear more or less blurry. For instance, the areas with the least amount of noise may be more blurry, while the areas with the most amount of noise may be less blurry. FIG. 5B illustrates this concept, as the areas in downscaled image 510 with the lowest amount of noise, e.g., pixel location 512, are the most blurry, and the areas with the highest amount of noise, e.g., pixel location 514, can be the least blurry.

As mentioned above, the downscaled pixels that are calculated most closely based on averaging original pixels may include less noise. Accordingly, when four original pixel values are roughly averaged, the downscaled pixel value is not very similar to any of the original pixel value. Indeed, in these downscaled pixel locations, because the calculation roughly averages original pixel values, there may not be much noise, but it will be different from any original pixel values, so the location will be blurry. In contrast, when an individual original pixel has more weight in calculating a downscaled pixel, it will be a dominant pixel and may result in more noise at that location. These noisy locations look more like an individual original non-scaled pixel, so they will be closest to one original pixel image and hence may not be blurry. When a downscaled image includes areas with increased noise combined with areas with decreased noise, it can be visually unpleasant. This disparity in the amount of noise within the same image is one of the issues presented when downscaling images.

The present disclosure can solve the aforementioned noise issues based on a number of approaches. In some aspects, the present disclosure can add an overlapping pixel range when calculating the downscaled pixel values. For instance, rather than using a pixel area equal in size to a downscaled pixel, in the present disclosure a pixel area greater in size to a downscaled pixel may be used. In these instances, for each direction surrounding a downscaled pixel, a uniformly spaced overlapping area of original pixel values can be added to the calculation. By adding these overlapping areas, the present disclosure can ensure that a wider range of original pixel values will be used in the downscaled pixel calculation by sampling from a greater amount of original pixel data. As the percentage or weight for each original pixel used will be more equal and/or include more components, the amount of noise in the downscaled pixel may be reduced.

In some aspects, when performing the pixel interpolation, e.g., adjusting the pixels in an image due to the image being resized or downscaled, the present disclosure can add the overlapping area to increase the covering pixel range in order to compensate for noise non-uniformity in the original image. Additionally, the noise distribution may correspond to using a larger scale factor or downscale ratio, which does not produce as many grid pattern artifacts. In some aspects, as the noise distribution may not manifest itself in grid pattern artifacts, the output image size may be downscaled using a small scale factor or downscale ratio. Moreover, in some instances, adding this overlapping area may result in an increased need for other aspects of the calculation, e.g., an increase in the amount of line buffers needed during calculation in order to account for the increased pixel coverage.

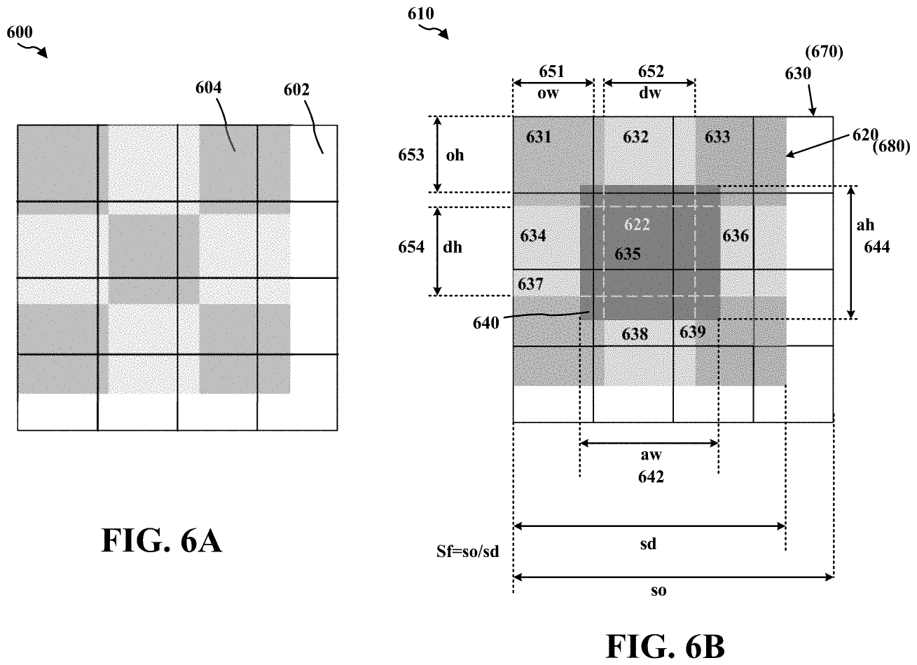

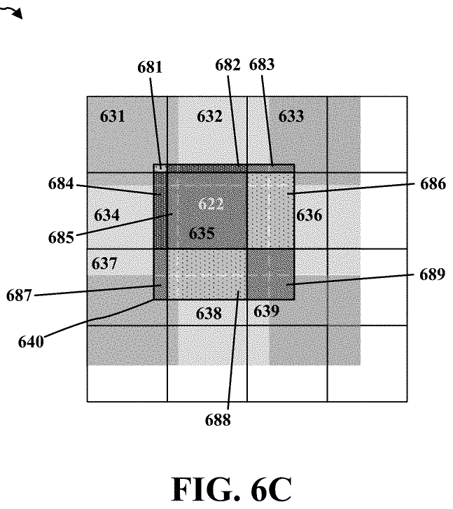

FIGS. 6A-6C illustrate examples of downscaling images 600, 610, and 690, respectively, according to the present disclosure. FIG. 6A shows an example of downscaling an image 600 including original pixels 602 and downscaled pixels 604. More specifically, FIG. 6A is an example of downscaling mentioned supra, wherein an overlapping region is not utilized. Accordingly, example 600 may only calculate downscaled pixel values based on the contributing percentage or weight of surrounding original pixels. As a result, FIG. 6A may experience some of the aforementioned noise issues when downscaling.

FIG. 6B shows an example of downscaling an image 610 including original pixels 630 and downscaled pixels 620. Original pixels 630 can constitute a first image 670 and downscaled pixels 620 can constitute a second image 680. Each of the original pixels 630 can include a first pixel width 651 (also referred to as ow) and a first pixel height 653 (also referred to as oh), and each of the downscaled pixels 620 can include a second pixel width 652 (also referred to as dw) and a second pixel height 654 (also referred to as dh). Original pixels 630 include pixel 631, pixel 632, pixel 633, pixel 634, pixel 635, pixel 636, pixel 637, pixel 638, and pixel 639. Downscaled pixels 620 include center downscaled pixel 622. Image 610 also includes overlapping region 640 including overlapping width 642 (also referred to as aw) and overlapping height 644 (also referred to as ah). FIG. 6B also shows scale factor, Sf, which can be determined by the following equation: Sf=so/sd, where so is the width of the original image, e.g., first image 670, and sd is the width of the downscaled image, e.g., second image 680.

FIG. 6C shows an example of downscaling an image 690. FIG. 6C displays center downscaled pixel 622, original pixels 631-639, overlapping region 640, and overlapping areas 681-689 that overlap with the corresponding original pixels 631-639. FIGS. 6B and 6C display how overlapping region 640, pixels 631-639, and overlapping areas 681-689 can be used to determine the center downscaled pixel 622.

In one aspect, FIGS. 6B and 6C shows that the present disclosure can obtain first image 670 including original pixels 630. The present disclosure can also determine a scale factor, Sf, for scaling the first image 670 from the original pixels 630 to the downscaled pixels 620. The number of downscaled pixels 620 can be less than the number of original pixels 630. As mentioned above, each original pixel 630 can have a first pixel width 651 and each downscaled pixel 620 can have a second pixel width 652. Additionally, the present disclosure can determine a value for each downscaled pixel 620 based on a weighted average. For example, each component of the weighted average can be a function of overlapping region 640 associated with center downscaled pixel 622 and values of corresponding original pixels 630, e.g. pixels 631-639. The overlapping region 640 can be centered around center downscaled pixel 622, where overlapping width 642 has a width greater than the second pixel width 652. The present disclosure can also generate the second image 680 based on the determined values for each downscaled pixel 620, where the second image 680 is a downscaled image from the first image 670.

Additionally, center downscaled pixel 622 can have a second pixel area equal to the second pixel width 652 multiplied by the second pixel height 654. Overlapping region 640 can have an overlapping area equal to overlapping width 642 multiplied by overlapping height 644. The overlapping area can be greater than the second pixel area. As shown in FIG. 6B, the second pixel width 652 can be greater than the first pixel width 651. As further shown in FIG. 6B, center downscaled pixel 622 can be determined based on values of pixels 631-639, wherein pixels 631-639 are adjacent center downscaled pixel 622. Moreover, overlapping region 640 can surround the center downscaled pixel 622 and extend past the center downscaled pixel 622. Additionally, second pixel height 654 can be greater than first pixel height 653. The overlapping area of overlapping region 640 can be equal to x*h*x*w, where h is the second pixel height 654, w is the second pixel width 652, and x>1. Accordingly, overlapping area can be greater than the area of a downscaled pixel 620, e.g. center downscaled pixel 622.

In further aspects, a number of components of the weighted average can be based on a scale factor. For instance, in some aspects, the number of components of the weighted average can be greater than or equal to four when the scale factor is less than 1.5. In other aspects, the range of the scale factor can be between 1.00001 and 1.3. In yet other aspects, the scale factor can be determined based on the amount of noise in the second image or based on a user input.

As mentioned above, some aspects of the present disclosure can utilize a weighted average to calculate the values of individual pixels. In one aspect, the value of the center downscaled pixel 622 may be determined based on a weighted average that is a function of the area 681 multiplied by the value of the pixel 631, the area 682 multiplied by the value of the pixel 632, the area 683 multiplied by the value of the pixel 633, the area 684 multiplied by the value of the pixel 634, the area 685 multiplied by the value of the pixel 635, the area 686 multiplied by the value of the pixel 636, the area 687 multiplied by the value of the pixel 637, the area 688 multiplied by the value of the pixel 638, and the area 689 multiplied by the value of the pixel 639. For example, the value of center downscaled pixel 622, e.g., P622, may be calculated based on the following equation: P622=[A681*P631+A682*P632+A683 *P633+A684*P634+A685*P635+A686*P636+A687*P637+A688*P638+A689*P639]/A640. In the above equation P631, P632, P633, P634, P635, P636, P637, P638, and P639 are the color values of original pixels 631-639, respectively, A681, A682, A683, A684, A685, A686, A687, A688, and A689 are the overlapping areas that overlap with the original pixels 631-639, respectively, and A640 is the area of overlapping region 640. As noted in FIG. 6C, the overlapping areas A681-A689 that are used in the calculation are indicated by a different pattern in order to emphasize the different overlapping areas that contribute to the calculation of the center downscale pixel 622. Accordingly, as shown in FIG. 6C, A685 will most heavily influence the value of P622, while A681 will have the least influence on P622. As mentioned previously, the percentage of influence that each original pixel 630 has on a downscaled pixel's value will change for each different downscaled pixel 620.

As mentioned above, when using the overlapping techniques described above, the least noisy areas of a downscaled image can be calculated using a near equal average of the original pixels. In some instances, the least noisy areas of an original image may have a similar noise amount in the downscaled image. For relatively noisy areas, the noise amount may decrease because the overlapping region adds more original pixel areas to average during the calculation. Essentially, the use of an overlapping area such as overlapping region 640 includes more original pixels for averaging when calculating downscaled pixels.

As indicated previously, when overlapping areas such as overlapping region 640 are added, the area of the coverage used to calculate the downsizing pixels is expanded, which can result in the reduction or elimination of the aforementioned grid artifacts. As mentioned above, when the scale factor or downscale ratio is small, e.g., between 1.00001 and 1.3, there is a tendency to produce noise pattern artifacts when using traditional downsizing methods. However, the use of overlapping regions, e.g., overlapping region 640, will reduce the likelihood of obtaining these noise pattern artifacts. Indeed, by adding an overlapping area and increasing the downsizing calculation area, the difference in original pixels used during the calculation is diluted, such that the grid patterns artifacts will be reduced. Accordingly, adding areas of overlap to the downscaling calculation will increase the percentage of areas that are being weighted, e.g., especially for smaller sampled areas, which may result in a more even distribution of original pixels used in the calculation.

As shown in FIGS. 6B and 6C, the overlapping region, e.g. overlapping region 640, is centered around each of the pixels being downscaled, e.g., center downscaled pixel 622. In some aspects, the present disclosure can perform this overlapping calculation for each and every downscaled pixel. As such, there can be equal amounts of overlap used to calculated each of the downscaled pixels. For instance, although FIGS. 6B and 6C only show the added overlapping region 640 for the center downscaled pixel 622, there can be an equal amount of overlapping region 640 used to calculate any of downscaled pixels 620. Additionally, the present disclosure can utilize a number of different overlapping regions to calculate downscaled pixels. For example, FIG. 6B shows the amount of overlapping region 640 on both sides of center downscaled pixel 622 can be equal to half the width of center downscaled pixel 622, e.g. half of second pixel width 652. As further shown in FIG. 6B, the second pixel width 652 may be equal to second pixel height 654. Accordingly, in some aspects, the amount of overlap on any one side of center downscaled pixel 622 may be equal to second pixel width 652 divided by four. If second pixel width 652 is equal to one pixel, then the amount of overlap on the side of, above, or below center downscaled pixel 622 will be 1/4 pixel. In other aspects, the amount of overlap on any side of a downscaled pixel 620 can be equal to a variety of different values, e.g., 2 pixels, 1 pixel, 1/2 pixel, 1/4 pixel, 1/8 pixel, 1/16 pixel, 1/32 pixel, etc.

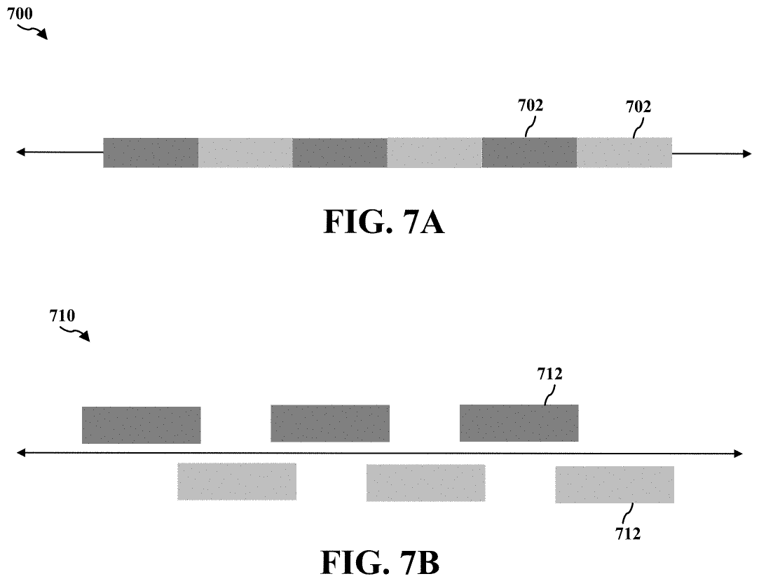

FIGS. 7A and 7B illustrate examples of downscaling an image 700 and an image 710, respectively, according to the present disclosure. More specifically, FIGS. 7A and 7B display a one dimensional view of downscaling an image 700 and an image 710, respectively. FIG. 7A illustrates a one dimensional view when downscaling an image 700 without using an overlapping region. As shown in FIG. 7A, there is no overlap or gap between downscaled pixels 702. In examples such as FIG. 7A, the downscaling can be relatively simple to implement, e.g., there may be only one line buffer needed to perform the calculations. FIG. 7B illustrates a one dimensional view when downscaling an image 710 using an overlapping region. As shown in FIG. 7B, there is an overlap or gap between downscaled pixels 712. As mentioned above, in order to calculate a downscaled pixel when downscaling an image 710, the present disclosure can add overlapping regions to the right and the left of that pixel, and then average the original pixel values in between the surrounding overlapping areas. As shown in FIG. 7B, since there are overlapping portions present to calculate a downscaled pixel, the downscaling may be more complicated to implement, e.g., there may be an additional line buffer needed to perform the downscaling calculation. Line buffers may carry out these calculations in a number of different manners, such as by performing a running average of the sum variables and storing the calculations in a memory location. Further, the number of line buffers needed to implement the aforementioned calculations may be equal to the amount of overlap in terms of pixels. For example, if the overlapping region overlaps the downscaled pixel by one pixel, then one additional line buffer may be needed.

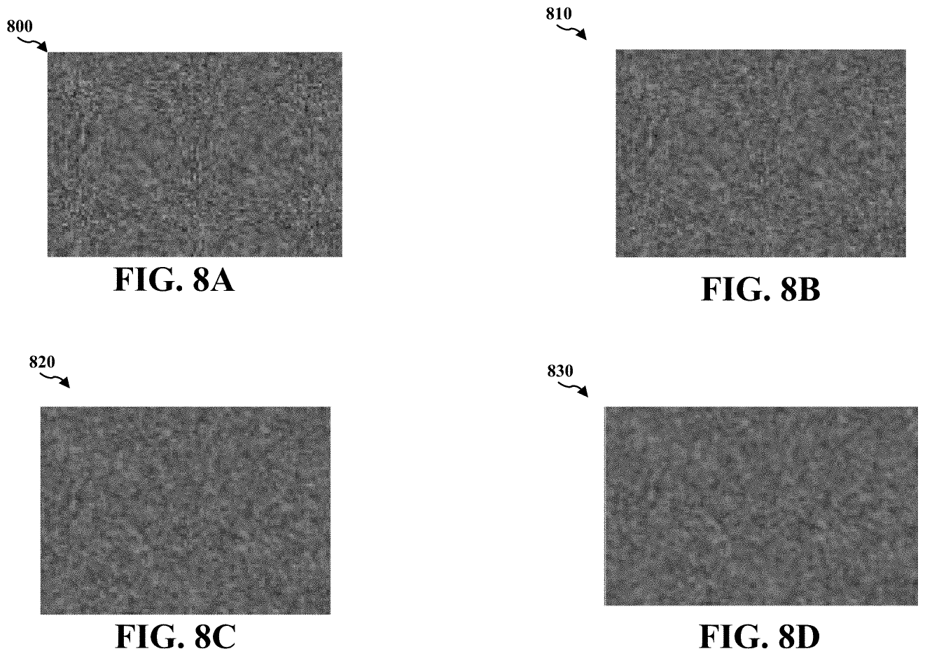

FIGS. 8A-8D illustrate examples of noise associated with a downscaled images 800, 810, 820, and 830, respectively, according to the present disclosure. FIG. 8A shows an example of noise associated with a downscaled image 800. In downscaled image 800, there is no overlapping area used when calculating the downscaled pixels. As indicated previously, the grid pattern of noise artifacts is more pronounced and easily noticed in FIG. 8A. FIG. 8B shows an example of noise associated with a downscaled image 810. For instance, in downscaled image 810, the downscaled pixels were calculated using an overlapping region with a length of 0.25 pixel. Compared to downscaled image 800 in FIG. 8A, the grid pattern of noise artifacts in downscaled image 810 is less pronounced. FIG. 8C shows an example of noise associated with a downscaled image 820. In downscaled image 820, the downscaled pixels were calculated using an overlapping region with a length of 0.5 pixel. Compared to downscaled image 810 in FIG. 8B, the grid pattern of noise artifacts in downscaled image 820 is even less pronounced. FIG. 8D shows an example of noise associated with a downscaled image 830. In downscaled image 830, the downscaled pixels were calculated using an overlapping region with a length of 0.75 pixel. Compared to downscaled image 820 in FIG. 8C, the grid pattern of noise artifacts in downscaled image 830 is even less pronounced and/or is no longer visible. FIG. 8D displays that downscaled image 830 is the most blurry compared to images 800, 810, and 820, which shows that the amount of blurriness can correspond to a reduction in the grid pattern artifacts. Additionally, the examples in FIGS. 8A-8D manifest that using an increased overlapping region to calculate downscaled pixels can result in a reduction of noise artifacts.

As mentioned above and shown in FIGS. 6B, 6C, 7A, 7B, and 8A-8D, adding an overlapping region when calculating a downscaled pixel can help to reduce grid pattern artifacts, e.g., especially when using a small scale factor or downscale ratio. This overlapping region can be added when performing the downscaled pixel value interpolation. Further, grid pattern noise artifacts can be less pronounced when calculating the downscaled image using an increased overlapping area in the original image pixels. This overlapping region can be an adjustable parameter setting when calculating downscaled pixels. For instance, when an image is noisy, the overlapping region can be increased, such that the grid pattern artifacts will not be as pronounced. Further, when image is less noisy, the overlapping region can be decreased. In some aspects, the present disclosure can determine the amount of noise in an image. For example, the amount of noise in an image can be determined by a device or apparatus. Moreover, in some aspects, the amount of noise in an image can be an adjustable parameter setting that can be set by a user.

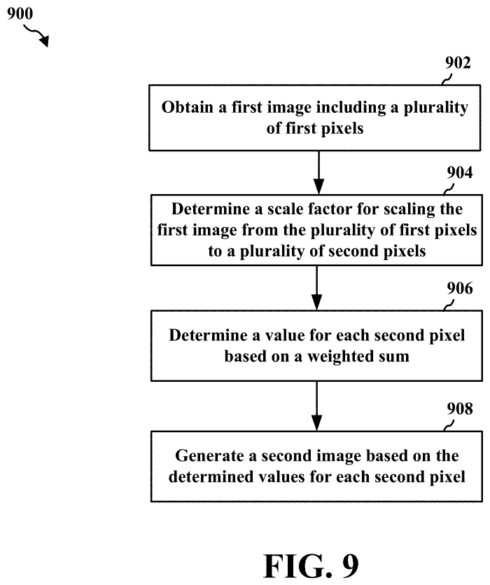

FIG. 9 illustrates an example flowchart 900 of an example method in accordance with one or more techniques of this disclosure. The method may be performed by an image processor or apparatus for image processing. At 902, the apparatus may obtain a first image including a set of first pixels, as described in connection with the examples in FIGS. 6B, 6C, and 7B. For example, as shown in FIG. 6B, first image 670 can be obtained including the set of original pixels 630. The present disclosure can obtain images in a number of different ways, e.g., images can be captured by a camera, processed in a specific processor such as an ISP, stored and then processed at a later time, received from another device, and/or created without using a camera and stored on the device. Each first pixel can have a first pixel width, as shown in FIG. 6B. At 904, the apparatus can determine a scale factor for scaling the first image from the first pixels to a set of second pixels, as described in connection with the examples in FIGS. 6B, 6C, and 7B. For example, as shown in FIG. 6B, a scale factor can be determined for scaling the first image 670 from the original pixels 630 to the downscaled pixels 620. Scale factors according to the present disclosure can be determined in a variety of manners, e.g., by determining the noise level of the image or based on user input. Also, the number of the set of second pixels can be less than the number of the set of first pixels, as shown in FIGS. 6B and 6C. Moreover, each second pixel can have a second pixel width, as shown in FIG. 6B. In some aspects, the apparatus can be a wireless communication device.

At 906, the apparatus can determine a value for each second pixel based on a weighted average, as described in connection with the examples in FIGS. 6B, 6C, and 7B. Each component of the weighted average can be a function of an overlapping area associated with each second pixel and values of corresponding first pixels of the set of first pixels, as described in connection with FIGS. 6B and 6C. For example, as shown in FIGS. 6B and 6C, each component of the weighted average can be a function of overlapping region 640 associated with center downscaled pixel 622 and values of corresponding original pixels 630, e.g. pixels 631-639, and overlapping areas 681-689. Moreover, the overlapping area can be centered on each second pixel and have a width greater than the second pixel width, as described in connection with the examples in FIGS. 6B, 6C, and 7B. For instance, as shown in FIG. 6B, the overlapping region 640 can be centered on center downscaled pixel 622, where overlapping width 642 has a width greater than the second pixel width 652. At 908, the apparatus can generate a second image based on the determined values for each second pixel, where the second image can be a downscaled image from the first image, as described in connection with the examples in FIGS. 6B, 6C, and 7B. For example, as shown in FIG. 6B, the second image 680 can be generated based on the determined values for each downscaled pixel 620, where the second image 680 is a downscaled image from the first image 670. After the second image is generated, the present disclosure can use the image in a variety ways, e.g., the image can be stored on the device, output to a display, or transferred to another device.

Additionally, the second pixel can have a second pixel area and the overlapping area can be greater than the second pixel area, as described in connection with the examples in FIGS. 6B, 6C, and 7B. For example, as shown in FIG. 6B, center downscaled pixel 622 can have a second pixel area equal to the second pixel width 652 multiplied by the second pixel height 654, where overlapping region 640 can be greater than the second pixel area. Moreover, the second pixel width can be greater than the first pixel width, as described in connection with FIGS. 6B and 6C. As shown in FIG. 6B, the second pixel width 652 can be greater than the first pixel width 651. In some aspects, each second pixel can be determined based on values of the first pixels that correspond to pixels that are adjacent to the second pixel and within the overlapping area, as described in connection with FIGS. 6B and 6C. For instance, as shown in FIGS. 6B and 6C, center downscaled pixel 622 can be determined based on values of pixels 631-639, where pixels 631-639 are adjacent center downscaled pixel 622.

Additionally, the overlapping area for each second pixel can surround the second pixel and extend past the second pixel, as described in connection with FIGS. 6B and 6C. As shown in FIGS. 6B and 6C, overlapping region 640 can surround the center downscaled pixel 622 and extend past the center downscaled pixel 622. Each first pixel can have a first pixel height, and each second pixel can have a second pixel height greater than the first pixel height, as described in connection with FIGS. 6B and 6C. For instance, as shown in FIG. 6B, second pixel height 654 can be greater than first pixel height 653. Further, the overlapping area can be equal to x*h*x*w, where h is the second pixel height, w is the second pixel width, and x is greater than 1, as described in connection with FIGS. 6B and 6C. Indeed, as shown in FIG. 6B, the overlapping area of overlapping region 640 can be equal to x*h*x*w, where h is the second pixel height 654, w is the second pixel width 652, and x is greater than 1.

In some aspects, a number of components of the weighted average can be based on a scale factor value. For instance, the number of components of the weighted average can be greater than or equal to four when the scale factor is less than 1.5, as described in connection with the example in FIG. 6B. In other aspects, the range of the scale factor can be between 1.00001 and 1.3, as described in connection with the example in FIG. 6B. In yet other aspects, the scale factor can be determined based on the amount of noise in the second image or based on a user input, as described in connection with the example in FIG. 6B.

In one configuration, a method or apparatus for image processing is provided. The apparatus may be an image processor or some other processor in a GPU. In some aspects, the apparatus may be the ISP 104, the CPU 108, the ASIC 120, the image processing unit 122, the video processing unit 124, or some other processor or hardware within system 100 or another device. In some aspects, the apparatus can be a wireless communication device. The apparatus may include means for obtaining a first image including a set of first pixels, where each first pixel has a first pixel width. The apparatus can also include means for determining a scale factor for scaling the first image from the set of first pixels to a set of second pixels. In some aspects, a number of the set of second pixels can be less than a number of the set of first pixels, where each second pixel as a second pixel width. The apparatus can also include means for determining a value for each second pixel based on a weighted average. In some aspects, each component of the weighted average can be a function of an overlapping area associated with each second pixel and values of corresponding first pixels of the set of first pixels. Further, the overlapping area can be centered on each second pixel and have a width greater than the second pixel width. Also, the apparatus can include means for generating a second image based on the determined values for each second pixel, where the second image can be a downscaled image from the first image.

The subject matter described herein can be implemented to realize one or more benefits or advantages. For instance, the described techniques herein can be used by image processors or other processors to help reduce or eliminate unwanted noise artifacts, such as through the use of overlapping areas of original image pixels when calculating a downscaled pixel. These overlapping areas can be adjustable as a parameter. In addition, the cost of adding these overlapping areas can be low, as well as be relatively simple to implement during the calculation of a downscaled pixel. Accordingly, the present disclosure can reduce grid pattern noise artifacts by adding overlapping areas, and these overlapping areas can be adjustable to achieve different effects based on different cases.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can be RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of image processing, comprising:
obtaining a first image including a plurality of first pixels, each first pixel of the plurality of first pixels having a first pixel width;
determining a scale factor for scaling the first image from the plurality of first pixels to a plurality of second pixels, a number of the plurality of second pixels being less than a number of the plurality of first pixels, each second pixel of the plurality of second pixels having a second pixel width;
determining a value for each second pixel based on a weighted average, each component of the weighted average being a function of an overlapping area associated with each second pixel and values of corresponding first pixels of the plurality of first pixels, the overlapping area being centered on each second pixel and having a width greater than the second pixel width; and
generating a second image based on the determined values for each second pixel, the second image being a downscaled image from the first image.

2. The method of claim 1, wherein the second pixel has a second pixel area, and the overlapping area is greater than the second pixel area.

3. The method of claim 1, wherein the second pixel width is greater than the first pixel width.

4. The method of claim 1, wherein each second pixel is determined based on values of the first pixels that correspond to pixels that are adjacent to the second pixel and within the overlapping area.

5. The method of claim 1, wherein the overlapping area for each second pixel surrounds the second pixel and extends past the second pixel.

6. The method of claim 1, wherein each first pixel has a first pixel height, each second pixel has a second pixel height greater than the first pixel height, and the overlapping area is equal to x*h*x*w, where h is the second pixel height, w is the second pixel width, and

7. The method of claim 1, wherein a number of components of the weighted average is greater than or equal to four when the scale factor is less than 1.5.

8. The method of claim 1, wherein the range of the scale factor is between 1.00001 and 1.3.

9. The method of claim 8, wherein the scale factor is determined based on the amount of noise in the first image or based on a user input.

10. An apparatus for image processing, comprising:
a memory; and
at least one processor, implemented in circuitry, coupled to the memory and configured to:
obtain a first image including a plurality of first pixels, each first pixel of the plurality of first pixels having a first pixel width;
determine a scale factor for scaling the first image from the plurality of first pixels to a plurality of second pixels, a number of the plurality of second pixels being less than a number of the plurality of first pixels, each second pixel of the plurality of second pixels having a second pixel width;
determine a value for each second pixel based on a weighted average, each component of the weighted average being a function of an overlapping area associated with each second pixel and values of corresponding first pixels of the plurality of first pixels, the overlapping area being centered on each second pixel and having a width greater than the second pixel width; and
generate a second image based on the determined values for each second pixel, the second image being a downscaled image from the first image.

11. The apparatus of claim 10, wherein the second pixel has a second pixel area, and the overlapping area is greater than the second pixel area.

12. The apparatus of claim 10, wherein the second pixel width is greater than the first pixel width.

13. The apparatus of claim 10, wherein each second pixel is determined based on values of the first pixels that correspond to pixels that are adjacent to the second pixel and within the overlapping area.

14. The apparatus of claim 10, wherein the overlapping area for each second pixel surrounds the second pixel and extends past the second pixel.

15. The apparatus of claim 10, wherein each first pixel has a first pixel height, each second pixel has a second pixel height greater than the first pixel height, and the overlapping area is equal to x*h*x*w, where h is the second pixel height, w is the second pixel width, and x>1.

16. The apparatus of claim 10, wherein a number of components of the weighted average is greater than or equal to four when the scale factor is less than 1.5.

17. The apparatus of claim 10, wherein the range of the scale factor is between 1.00001 and 1.3.

18. The apparatus of claim 17, wherein the scale factor is determined based on the amount of noise in the first image or based on a user input.

19. The apparatus of claim 10, wherein the apparatus is a wireless communication device.

20. A computer-readable medium storing computer executable code for image processing, comprising code to:
obtain a first image including a plurality of first pixels, each first pixel of the plurality of first pixels having a first pixel width;
determine a scale factor for scaling the first image from the plurality of first pixels to a plurality of second pixels, a number of the plurality of second pixels being less than a number of the plurality of first pixels, each second pixel of the plurality of second pixels having a second pixel width;
determine a value for each second pixel based on a weighted average, each component of the weighted average being a function of an overlapping area associated with each second pixel and values of corresponding first pixels of the plurality of first pixels, the overlapping area being centered on each second pixel and having a width greater than the second pixel width; and
generate a second image based on the determined values for each second pixel, the second image being a downscaled image from the first image.

21. The computer-readable medium of claim 20, wherein the second pixel has a second pixel area, and the overlapping area is greater than the second pixel area.

22. The computer-readable medium of claim 20, wherein the second pixel width is greater than the first pixel width.
